(19) United States
(12) Patent Application Publication
(10) Pub. No.: US 2013/0229584 A1
(43) Pub. Date: Sep. 5, 2013

(54) SYSTEMS AND METHODS FOR MULTI-BAND SET TOP BOX CONTROL OF A DISPLAY DEVICE

(71) Applicants: Robert Andrew Rhodes, Carmel, IN (US); Robert F. Reiter, Westfield, IN (US)

(72) Inventors: Robert Andrew Rhodes, Carmel, IN (US); Robert F. Reiter, Westfield, IN (US)

(73) Assignee: THOMSON LICENSING, Issy de Moulineaux (FR)

(21) Appl. No.: 13/883,636

(22) PCT Filed: Nov. 9, 2010
(86) PCT No.: PCT/US10/02947

§ 371 Date: May 6, 2013

(51) Int. Cl. H04N 21/41

(52) U.S. Cl. CPC H04N 21/4126
USPC 348/734

(57) ABSTRACT

A multi-band mobile device provides communications between a set top box and a display device. The multi-bands can include, but are not limited to, radio frequency (RF) and infrared (IR) bands of communication. The multi-band mobile device relays information between at least two communication bands through transmitters and/or receivers for a particular frequency band. The multi-band mobile device can also provide information formatting if required before relaying it. The ability to use RF in the set top box gives it the freedom to be placed in locations that would not be possible with ordinary IR only line of sight communications.

### BACKGROUND

In the commercial hospitality industry, media entertainment services are typically provided by large receiver/transcrypter systems which can receive satellite broadcast services. These systems then decrypt video streams and re-encrypt them for local distribution. The end display devices then decrypt the video streams with built-in decryption components. However, other markets may not have end display devices with internal decryption components. In these markets, the end display devices can be just ordinary consumer grade flat panel televisions and the like. Thus, a set top box developed for this application would need to provide communication between the incoming video streams and the display device. This is typically accomplished using wired connections between the set top box and the display.

One solution is to connect an infrared blaster to the set top box to interface with the displays infrared receiver that accepts remote control commands. An IR blaster requires some type of line of sight to the display's IR receiver which is typically located on the front of the display. This presents a large problem when the set top box is hidden away or mounted out of line of sight of the display. Another solution is to use a data port to connect the set top box to the display. However, this requires that the display is manufactured with a data port and the data port is compatible with the set top box controls.

### SUMMARY

A multi-band mobile device is leveraged to provide communications between a set top box and a display device. The multi-bands can include, but are not limited to, radio frequency (RF) and infrared (IR) bands of communication. The multi-band mobile device relays information between at least two communication bands. By utilizing this device, a set top box equipped with RF communications can interface with a display through the multi-band mobile device, eliminating any need for special communication ports or IR blasters and the like. This significantly reduces the cost of display devices as ordinary consumer grade displays can be used. The ability to use RF in the set top box gives it the freedom to be placed in locations that would not be possible with ordinary IR only line of sight communications.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a block diagram of a multi-band mobile device system in accordance with an aspect of an embodiment.

FIG. 2 is an example environment in which a multi-band mobile device can be employed in accordance with an aspect of an embodiment.

FIG. 3 is a flow diagram of a method of relaying command signals through a multi-band mobile device in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

A multi-band mobile device provides communication and communication translations between at least two different types of wireless communication. Although subsequent examples show embodiments that might utilize display devices as the controlled device, the multi-band mobile device can be utilized to control other types of devices as well (e.g., radios, computers, cell phones, etc.). This allows, for example, a set top box to communicate with a standard television, reducing the costs of the display equipment and allowing the set top box to interface with legacy displays. The set top box could also operate to control an associated computer to allow access to additional media source material, etc. by commanding the computer on and off, etc. If one of the communication bands is RF based, this also permits, for example, a set top box to be located beyond or out of line of sight of a display's IR receiver. The following instances can be incorporated into dedicated devices (e.g., a remote control device for a television set and/or a set top box) and/or to non-dedicated devices (e.g., a cellular communication device equipped with multi-band capabilities, a portable computing device with multi-band capabilities and the like.)

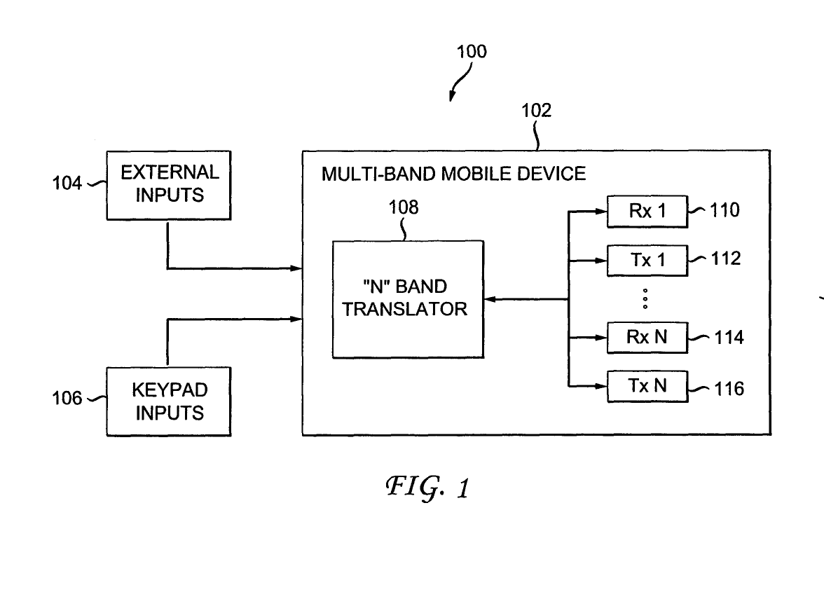

FIG. 1 depicts a multi-band mobile device system 100 that utilizes a multi-band mobile device 102 with optional external inputs 104 and/or optional keypad inputs 106. The multi-band mobile device 102 has an “N” band translator 108 that interfaces with receivers and transmitters (110-116) associated with 1 to N bands of communication, where N is an integer from one to infinity. The receivers/transmitters (110-116) typically operate in receiver and transmitter pairs for each band of communication. This allows for bidirectional communication on each band. However, it is not required that each band have bidirectional capability (i.e., receiver/transmitter pairs). For example, the multi-band mobile device 102 can communicate with a set top box in an RF band with bidirectional capability but only have unidirectional communication with a display (e.g., IR commands are only sent to the display—the display does not respond with IR).

The multi-band mobile device 102 can also receive external inputs 104 and/or keypad inputs 106. These optional inputs 104, 106 can be used to program and/or otherwise influence the translation of the communications between bands and/or to select which bands to use for communicating and the like. For example, the external inputs 104 can include a wired and/or wireless connection to program the translator and/or the transmitters/receivers. Likewise, the keypad inputs 106 can be used to select between bands and/or change active bands, etc. Transmission codes can also be entered by either input method 104, 106. In the same manner, encryption/decryption and/or encoder/decoder information can be programmed. Transmitters and/or receivers can also be individually controlled and turned on or off.

The “N” band translator 108 can encompass, for example, encoders and/or decoders necessary to relay information between different bands of communication. The “N” band translator 108 can also have encrypters and/or decrypters to aid in relaying communications between devices if the communications are encrypted. Since the “N” band translator 108 can provide relay services for multiple communication bands, it can also relay information from one band to multiple outgoing bands of communications (“one to many”). For example, if a set top box communicating via RF desires to power off multiple televisions and a radio in a room at once, the multi-band mobile device 102 can relay this to the displays over IR and to the radio possibly over RF. It is also possible for it to relay information from multiple bands to a single band of communication (“many to one”). For example, displays with send and receive IR capability could report what channel they are on and the multi-band mobile device 102 can summarize this information and then transmit it to a set top box over RF communications.

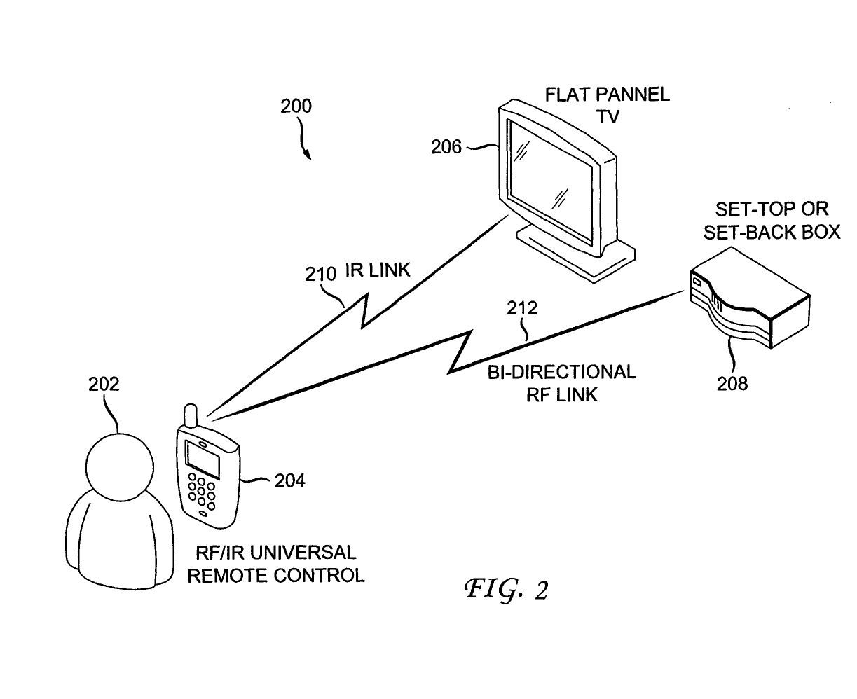

FIG. 2 illustrates a typical environment 200 in which one embodiment of a multi-band mobile device can be used. In this example, a user 201 employs a multi-band mobile device 204 that is embodied as a remote control for a television set 206. Video and/or audio content intended for display on the television set 206 comes from the set top box (or set-back box as the case may be) 208. Typically, the set top box 208 is hardwired to the television set 206 for transferring media content. However, these hardwired communication channels do not ordinarily allow control information to be passed from the set top box 208 to the television set 206. Thus, if the set top box 208 desires to turn the television set 206 on or off it cannot do so.

But, with the multi-band mobile device 204 in place, the set top box 208 can communicate to the television set 206 through it. In this instance, the multi-band mobile device 204 is communicating with the set top box 208 with a bidirectional RF link 212 and is communicating with the television set 206 with a unidirectional IR link 210. This allows the set top box 208 to turn the television set 206 off by sending an off command over the RF band to the multi-band mobile device 204. The multi-band mobile device 204 then relays this command to the television set 206 over the unidirectional IR link 210, turning the television set 206 off. In another instance, the multi-band mobile device 204 can then send a response back to the set top box 208 over the bidirectional RF link 212 to inform the set top box that the command has been sent to the television set 206.

In another instance, a multi-band mobile device and a set top box are designed using a universal, dual band IR/RF system using the RF4CE (Radio Frequency for Consumer Electronics) communications protocol between the multi-band mobile device (e.g., remote control) and the set top box and IR between the multi-band mobile device and the television. A “universal” remote (example of a multi-band mobile device) allows it to sync with any number of coded IR signals used with different brands of televisions. This provides a means for using a dual band (RF and IR) TV remote control to allow a set top box to control the TV without an IR blaster or other connection by using a return channel RF connection from the set top box to allow it to send commands to the TV using the remote's IR transmitter. This eliminates the potential difficulty of a line of sight connection to a set top box and/or set back box in commercial deployments.

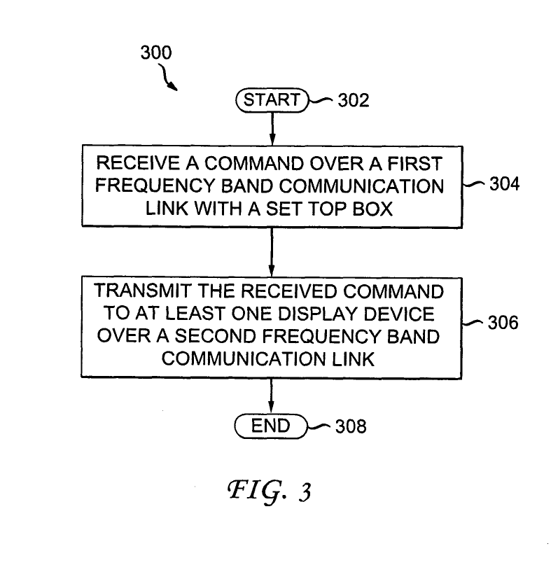

In view of the exemplary systems shown and described above, methodologies that can be implemented in accordance with the embodiments will be better appreciated with reference to the flow chart of FIG. 3. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 3 shows a method 300 that starts 302 by receiving a command over a first frequency band communication link (e.g. a bidirectional RF communication link, etc.) with a set top box 304. The first frequency band can also be a bidirectional band that meets a standard for Radio Frequency for Consumer Electronics (RF4CE). The received command is then transmitted to at least one display device over a second frequency band (e.g., an IR communication link, etc.) communication link 306, ending the flow 308. The second frequency band can be bidirectional as well. The display device(s) are generally associated with the set top box that is supplying the commands to it. The set top box can be in a remote location in reference to the display. The RF band permits out of “line-of-sight” communications with the display device(s). It may also be necessary to translate a command (not shown in FIG. 3) from a set top box before relaying the command to the display device(s). The translation process can include reformatting the command information to adhere to a particular transmission standard for a given frequency band and/or can include encoding, decoding, decrypting, and/or encrypting and the like. Feedback can also be sent to the set top box over a bidirectional link. The feedback can include, but is not limited to, information such as command received, command transmitted to display, commanded action performed, unable to process command, command transmission failed, etc.

It should be noted that instances herein can also include information sent between entities. For example, in one instance, a data packet, transmitted between two or more devices, that facilitates content/services distribution is comprised of, at least in part, information relating to content/service distribution receiver software relayed to content/service distribution receivers via a multicast message.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A multi-band control system, comprising:
a receiver and transmitter for a first frequency band;
at least a transmitter for a second frequency band; and
a band translator that receives information over the first frequency band and transmits the information over the second frequency band.

2. The system of claim 1, wherein the receiver and transmitter operate in a bidirectional radio frequency band.

3. The system of claim 2, wherein the radio frequency band meets a Radio Frequency for Consumer Electronics—RF4CE—standard.

4. The system of claim 1, wherein the at least a transmitter operates in an infrared frequency band.

5. The system of claim 1, wherein the multi-band control system is a remote control.

6. The system of claim 1, wherein the multi-band control system provides communication between a set top box and a television.

7. The system of claim 1, wherein the set top box is located remotely to the television.

8. The system of claim 1, wherein the band translator provides feedback over the first frequency band.

9. The system of claim 1, wherein the multi-band control system is a handheld remote control device.

10. The system of claim 1, wherein the multi-band control system is a handheld cellular communication device.

11. A method for controlling devices, comprising the steps of:
receiving information transmitted in a first frequency band from a set top box;
translating the information for transmission over a second frequency band; and
transmitting the information to at least one display device over the second frequency band.

12. The method of claim 11, further comprising the step of:
translating the information by utilizing at least one of a decoder, an encoder, a decrypter and an encrypter.

13. The method of claim 11, further comprising the step of:
receiving the information over a bidirectional radio frequency band from the set top box.

14. The method of claim 13, further comprising the step of:
transmitting feedback to the set top box over the bidirectional radio frequency band.

15. The method of claim 11, further comprising the step of:
transmitting the information to the at least one display device using an infrared frequency.

16. A system that controls devices, comprising:
means for receiving information transmitted in a first frequency band from a set top box;
means for translating the information for transmission over a second frequency band; and
means for transmitting the information to at least one display device over the second frequency band.

17. The system of claim 16, further comprising:
means for transmitting and receiving a bidirectional radio frequencies to and from a set top box; and
means for transmitting infrared frequencies to a display device associated with the set top box.
